(19) United States
(12) Patent Application Publication
(10) Pub. No.: US 2021/0174218 A1
(43) Pub. Date: Jun. 10, 2021

(54) SELF-ORGANIZING DATA CAPTURE, ANALYSIS, AND COLLABORATION SYSTEM

(71) Applicant: PIVOT INDUSTRIES LIMITED, Roxborough, CO (US)

(72) Inventors: James M. Miller, Roxborough, CO (US); Nabih Saliba, Littleton, CO (US); Ravi Bhalotia, Littleton, CO (US)

(21) Appl. No.: 17/071,772

(22) Filed: Oct. 15, 2020

Related U.S. Application Data
(60) Provisional application No. 62/916,436, filed on Oct. 17, 2019.
(60) Provisional application No. 63/066,002, filed on Aug. 14, 2020.
(60) Provisional application No. 63/084,282, filed on Sep. 28, 2020.

(51) Int. Cl. G06N 5/02; G06N 20/00; G06K 9/46

(52) U.S. Cl. CPC G06N 5/02; G06K 9/46; G06N 20/00

(57) ABSTRACT

A self-organizing knowledge collaboration system (100) is shown includes a cloud-based platform (102) that can be accessed by a variety of users (104) to build and share knowledge and to collaborate. The users (104) can exchange information with the platform (102) and each other via a network (108). A front-end user (112) can submit requests concerning management of the asset (106) to the platform 102 together with information concerning the asset (106) in various forms. In response to requests from the front-end user (110) or otherwise, the front-end user (110) and/or other users (104) may receive data, reports, collaborative messages or conversations (e.g., via voice, text, chat, etc.), or other information related to management of the asset (106).

### REFERENCE TO RELATED APPLICATIONS

The application is a non-provisional of U.S. Patent Application No. 62/916,436 entitled, ‘SELF-ORGANIZING KNOWLEDGE BASE FOR ASSET INFORMATION,” filed Oct. 17, 2019, U.S. Patent Application No. 63/066,002 entitled, “SELF-ORGANIZING KNOWLEDGE BASE FOR ASSET INFORMATION,” filed Aug. 14, 2020, and U.S. Patent Application No. 63/084,282 entitled, “SELF-ORGANIZING KNOWLEDGE BASE FOR ASSET INFORMATION,” filed Sep. 28, 2020 (collectively, the “parent applications”) and claims priority from Parent Applications to the maximum extend permissible under applicable laws and regulations. The Parent Applications are incorporated by reference herein in its entirety.

### FIELD OF THE INVENTION

The present invention relates generally to accessing information to facilitate desired services such as managing assets and, in particular, to a platform for intelligently analyzing service requests to identify relevant resource materials and subject matter experts as well as to facilitate collaboration in furtherance of providing the desired services.

### BACKGROUND OF THE INVENTION

In many contexts, it would be useful to efficiently match service providers with resources for servicing an asset, i.e., any subject of services. One such context is the case of managing a capital-intensive asset such as: an aircraft, sophisticated weaponry, or civilian or military assets; dams, power plants or other infrastructure assets; or hospital equipment, factory equipment or other capital assets. Managing the asset may involve servicing, repairs, maintenance, re-building, replacement or other services. While the invention is not limited to use in connection with such capital-intensive assets, this is a useful context for understanding certain advantages of the invention because the need to efficiently service such assets is particularly acute.

Today, the tools available to a service provider in such contexts are limited. The service provider, of course, relies on his or her own expertise and may consult peers and service manuals. In difficult cases, the service provider may conduct additional research and may attempt to identify and contact an expert in the relevant field. However, such efforts may be hampered for a number of reasons. In some cases, research may reveal little, for example, if the issue is unusual or unreported. In other cases, the service provider may have difficulty in describing the problem in a way that yields meaningful results. Even if the service provider succeeds in contacting an expert in the relevant field, it may be difficult to share information in a manner that facilitates productive collaboration. As a result, servicing delays and costs may be increased and asset down-time may be extended.

### SUMMARY OF THE INVENTION

The present invention is directed to a system (apparatus and associated functionality) for efficiently accessing information and enabling collaboration in connection with a given collaboration environment, e.g., managing an asset. Asset information relating to requests and responses is ingested from many sources and collected in a self-organizing knowledge base. The asset information is thus readily accessed in relation to subsequent requests so that users can efficiently utilize resource materials, subject matter experts, and other resources to resolve service issues or otherwise obtain desired information.

In accordance with one aspect of the present invention, a system is provided for enabling users to access asset information in connection with providing services for managing an asset. The asset may be a capital-intensive asset as discussed above. However, the various aspects of the invention are not limited to use in connection with such assets and may involve other types of assets for which resources and/or collaboration is desired—for example, a medical patient, a diseased crop or plant, or the subject of a test or research—or other subject of inquiry, research or collaboration. The system includes a knowledge engine, a front-end module and a back-end module. The knowledge engine receives asset information from multiple sources concerning assets and associated services. The knowledge engine is further operative for parsing communications concerning the assets and services, tagging the resulting items of information with metadata related to each of the assets and services to provide processed items of information, and storing the processed items of information in the knowledge base. Upon receiving requests for asset information, the knowledge engine can process the requests and provide outputs using one or more of the processed items of information.

The front-end module is disposed on a device of a user at an asset location or a remote location and is operative for uploading to the knowledge engine asset information related to one or both of a first asset and first services for the first asset. For example, a user may use the front-end module to upload a search request, an image or video related to the subject services, or other media. Another user, such as a subject matter expert, may use the front-end module to upload information responsive to a service request. The back-end module runs on a platform of an operator of the first asset and is operative for accessing an existing system of the operator relating to subject assets of the operator and services for the subject assets. The back-end module is further operative for providing asset information concerning the first asset to the knowledge engine. The system thus allows users to access a rich knowledge base of information concerning assets and associated services.

In accordance with another aspect of the present invention, a self-organizing knowledge base system is provided. The system includes an ingest engine, a machine learning engine, and a distribution framework. The ingest engine receives asset information from multiple sources concerning assets and associated services, pre-processes the asset information to provide preprocessed asset information, and stores the preprocessed asset information in a data lake. The machine learning engine receives training information and develops modeling information for applying a data model to preprocessed asset information to generate structured asset information that can be stored in a data warehouse and to generate access information for accessing the structured asset information in accordance with the data model. The distribution framework receives requests for asset information and provides responses to the request by accessing structured asset information from the data warehouse using the data model. The self-organized knowledge base system thus provides great flexibility for intelligently organizing information from multiple sources relating to assets and associated services.

The system can process information from a variety of sources, both to receive requests and build the knowledge base. In addition to text and other sources as noted above, the system can capture and generate structured data from chat conversations, video conferences, and images including images captured from pdf documents. In the case of chats, a data capture may be initiated by monitoring a chat conversation transmitted via a platform of the knowledge base system. Thus, for example, if a technician initiates a chat conversation with a subject matter expert, the system may process the chat content to identify the asset involved, the nature of the issue, and any solutions discussed or developed in the course of the chat conversation. The information thus extracted can be annotated and structured (e.g., in relation to the asset, asset class, system(s) implicated, nature of the problem, subject matter expert enlisted, problem and solutions, among other things), as well as being stored and rendered searchable for future use.

Similarly, image information can be captured, structured and stored. Such image information may be included in pdf documents or in other imaging formats, including still frame and video images. As noted above, technicians, subject matter experts, and others may share images related to servicing an asset or other contexts. It will be appreciated that a large volume of information can be conveyed in this fashion, including information that may be difficult to articulate fully. The system of the present invention can extract image information from such electronic images. This may involve feature recognition from the image as well as context cues extracted from surrounding information such as location, parties involved, text messages, and the like. In this manner, the image information can be associated with metadata, stored and rendered searchable. Image information may then be used, for example, to extract service information related to servicing a specific issue related to a specific asset and a subsequent inquiry may be addressed using information derived from the image and/or the image itself.

The information captured using any of these techniques and sources may be processed using algorithms, machine learning, or combinations thereof. This may involve classification and clustering. Classification refers to organizing information relative to categories or fields of information, for example, defining a hierarchy of information concerning a subject. Such classifications may be pre-defined or developed over time by machine learning or otherwise. The classifications will be context dependent but, in the exemplary case of servicing military or civilian hardware, some classifications may relate to: the asset, type of asset or category of asset; the location of the asset, the technician, the subject matter expert or others; the nationality or service affiliation of the technician, subject matter expert, or other party; the system or part involved; the condition or indication that prompted the inquiry; any images, diagnostics or other data conveyed in connection with a service request; and any diagnoses, solutions or suggestions made in response to the request. In this regard, similar subject matter may be gathered by classification or clustered by machine learning tools such that the most relevant information can be readily accessed in relation to a new inquiry. Such clustering may be implemented in relation to multiple dimensions that may be predefined and/or developed based on machine learning.

In accordance with a still further aspect of the present invention, a system is provided for enabling collaboration with respect to asset information. The system involves a collaboration platform including a processing module, a matching module, and a monitoring module. The processing module receives requests from a requester relating to performing a service for an asset. The matching module analyzes the request, identifies at least one subject matter expert in relation to the request, and enables a communications path between the requester and at least one subject matter expert via the collaboration platform. The monitoring module monitors communications between the requester and the subject matter expert via the communications path, parses the communication to obtain items of asset information, and associates metadata with at least one of the items of asset information concerning one or both of the service and the asset. For example, a voice communication between a service provider and a subject matter expert may be monitored so that information exchanged between the requester and subject matter expert can be structured and stored for subsequent use, e.g., in connection with similar service requests relating to similar assets.

In accordance with another aspect of the present invention, an expert management system is provided. The system includes a knowledge base, and ingestion module, a search engine, and an output module. The knowledge base includes service information based on previous service requests and responses to the service requests. Individual items of service information in the knowledge base are tagged with metadata concerning each of asset information for a subject asset and service information for a subject service. The ingestion module receives a service request and determines first request information concerning an asset that is a first subject of the request and second request information concerning a service that is a second subject of the request. The search engine uses the first and second request information to access responsive service information from the knowledge base. The output module outputs a response to the service request including the responsive service information. For example, the output module may output resource materials or identify a subject matter expert based on the type of asset and type of services requested.

### BRIEF DESCRIPTION OF THE DRAWINGS

For a more complete understanding of the present invention, and further advantages thereof, reference is now made to the following detailed description, taken in conjunction with the drawings, in which:

FIG. 1 is a block diagram of a self-organizing knowledge collaboration system in accordance with the present invention;

FIG. 2 is a schematic diagram illustrating the functionality of the system of FIG. 1;

FIG. 3 illustrates a data ingestion process in accordance with the present invention;

FIGS. 4A-4B illustrate data ingestion and enrichment processes in accordance with the present invention;

FIG. 5 is a schematic diagram of a data ingest engine in accordance with the present invention;

FIG. 6 illustrates a process for ingesting raw data and generating curated data in accordance with the present invention;

FIG. 7 illustrates a data analyzer system in accordance with the present invention;

FIG. 8 illustrates a distribution framework in accordance with the present invention; and

FIG. 9 provides an overview of self-organizing knowledge collaboration system functionality in accordance with the present invention.

### DETAILED DESCRIPTION

The present invention relates generally to a system for ingesting and organizing information from a variety of sources so as to enable users to access usable knowledge concerning a subject of interest and to enable collaboration concerning such a subject of interest. In many of the examples below, such knowledge and collaboration relates to maintaining, servicing, repairing, or otherwise managing a capital-intensive asset. While this is an advantageous implementation of the present invention, it will be appreciated that the invention is not limited to this context. Accordingly, the following description should be understood as illustrative and not by way of limitation.

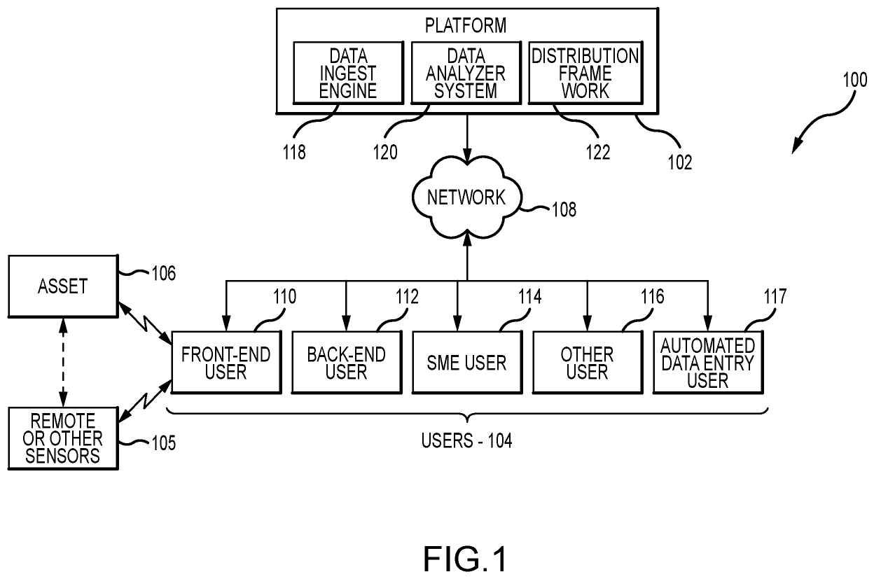

Referring to FIG. 1, a self-organizing knowledge collaboration system 100 is shown. The illustrated system 100 generally includes a cloud-based platform 102 that can be accessed by a variety of users 104 to build and share knowledge and to collaborate. In the illustrated implementation, such activity relates to managing a capital-intensive asset 106 such as, for example: an aircraft, sophisticated weaponry, or civilian or military assets; power plants or other infrastructure assets; or hospital equipment, factory equipment, or other capital assets. It will be appreciated, however, that knowledge can be accumulated and shared, and collaboration can occur, in other contexts not involving a capital-intensive asset. The users 104 can exchange information with the platform 102 and each other via a network 108 as will be described in more detail below.

As shown, a variety of users 104 may access the platform 102 including front-end users 110, back-end users 112, subject matter expert (SME) users 114 and others 116. One or more front-end users 112, in the illustrated example, are involved in managing the asset 106. As will be described in more detail below, the front-end user 112 can submit requests concerning management of the asset to the platform 102 together with information concerning the asset 106 in various forms such as text, photographs, video, chat streams, barcode scans, QR code scans, RF inputs, and others. Accordingly, the system 100 may further include one or more remote or other sensors 105 such as cameras, GPS units, temperature sensors, scanners, medical sensors, infrared sensors, remote sensing instruments, IoT devices, wearables, or other sensor systems. Moreover, the front-end user 110 may submit such information without any explicit request, for example, to assist in building a knowledge base concerning the asset. In this regard, it will be appreciated that the front-end user need not have a human operator. In some cases, for example, in connection with photographs or video streams obtained by a drone or other autonomous sensor system, the users 104 may include one or more automated data entry users 117.

In response to requests from the front-end user 110 or otherwise, the front-end user 110 and/or other users 104 may receive data, reports, collaborative messages or conversations (e.g., via voice, text, chat, etc.), or other information related to management of the asset 106. The front-end user 110 may use any user device suitable for submitting the requests and receiving the responsive information and multiple user devices may be employed in this regard. In many cases related to managing an asset 106, a mobile device such as a phone or tablet computer may be used. Such devices conventionally have a number of functions that are useful in such contexts such as mobile data network access, location functionality, a camera for obtaining images, video, scanning and the like, text and chat functionality and other functionality. Additionally or alternatively, the front-end user may use a laptop computer, desktop computer, a separate camera, sensor systems, wearable devices, smart speakers, IoT devices, and/or other equipment. To provide a nonlimiting example to assist in understanding the present invention, a technician repairing and aircraft may discover, using a scope or probe, that a small fuel leak has deteriorated insulation and compromised a wiring harness. The technician may submit video from the scope or probe that shows the damage and, potentially, parts labels together with a request for information from a subject matter expert who has experience with the problem. In response, the system may return information for addressing the situation and/or identify an SME and establish a video conference to collaborate on a solution.

The users 104 may further include one or more back-end users 112. Back-end users 112 are distinguished from the front-end users 110, in this example, because the back-end users are not directly involved in managing the asset 106. However, such back-end users can provide a variety of information that is potentially or actually useful in processing a request from the front-end user or otherwise useful in managing the asset or building a knowledge base. For example, the back-end user 112 may provide various types of information, depending on the context, including user manuals, maintenance records, asset specifications, privacy or security parameters, part listings, vendor information, personnel attributes or classifications, or other information. The back-end user may or may not include a human operator. For example, in some cases, information may be accessed via messaging between systems via an API. In this regard, the back-end user 112 may involve a variety of equipment including, for example, servers, databases, and other systems of an interested entity. In addition, information may be exchanged between the back-end user 112 and the platform 102 via an interactive session with a human user via a laptop, desktop, phone, tablet computer, or other device.

The users 104 may also include one or more SME users 114. One of the objectives of the present invention is to facilitate collaboration, e.g., between a front-end user and an SME. As will be described in more detail below, based on a request from a front-end user 110, an SME user 114 may be identified via the platform 102 to collaborate with the front-end user 110. For example, the SME user 114 may be identified based on specific experience related to an event implicated by the request from the front-end user 110, specific experience with the asset 106 or class of asset, or expertise otherwise relevant to a given situation. To facilitate collaboration, the platform 102 may be employed to facilitate transfer of information between the SME user 114 and the front-end user 110, to initiate a chat concerning the situation, to initiate a phone or video conference, or to otherwise facilitate collaboration. Thus, the system 100 may enable a communication path (e.g., a chat pathway via the platform 102, a data channel for voice and/or video conferencing via the platform 102, etc.) between two or more of the users 104 via the platform 102 and monitor subsequent communications via the pathway. As will be understood from the description below, the ensuing transmission or exchange of information may be monitored by the platform 102 to harvest information to enrich a knowledge base. It will be appreciated that the SME user 114 may employ any suitable devices in this regard such as a phone, tablet computer, laptop computer, desktop computer, a camera, a wearable device, or any other suitable device.

In the illustrated embodiment, the users 104 may further include other users 116. It will be appreciated that the system 100 may obtain information from a variety of other sources to build a knowledge base or address specific requests. In this regard, the other users 116 may include systems of OEMs, repositories of articles or other literature, geographical information systems, or other systems as may be relevant in a particular context. Such information may be obtained via conversations or interactive sessions with human users and/or via system to system communications.

The illustrated processing platform 102 generally includes a data ingest engine 118, a data analyzer system 120 and a distribution framework 122. The data ingest engine 120 receives information from any of the users or other sources and preprocesses the information for use by the data analyzer system 120. The data analyzer system 120 develops data models for a given context (e.g., using artificial intelligence/machine learning), develops an augmented structure for the information, analyzes requests or other trigger events, accesses and processes relevant data, and provides output information. The distribution framework 122 uses the output information from the data analyzer system 120 to access and/or generate data, reports, images, videos, instructions, or other outputs for the front-end user 110 or other users 104. Though not shown in FIG. 1, the platform 102 may further include: monitoring modules, associated with the data ingest engine 118, for monitoring, transcribing, transforming, and extracting data from conversations, documents, and other source information; a first data repository or data lake for receiving, storing, and enabling access to raw or preprocessed data; a second data repository or data lake for receiving, storing, and enabling access to processed data, and other processing components. The data ingest engine 118, data analyzer system 120, and distribution framework 122 will be described in more detail below.

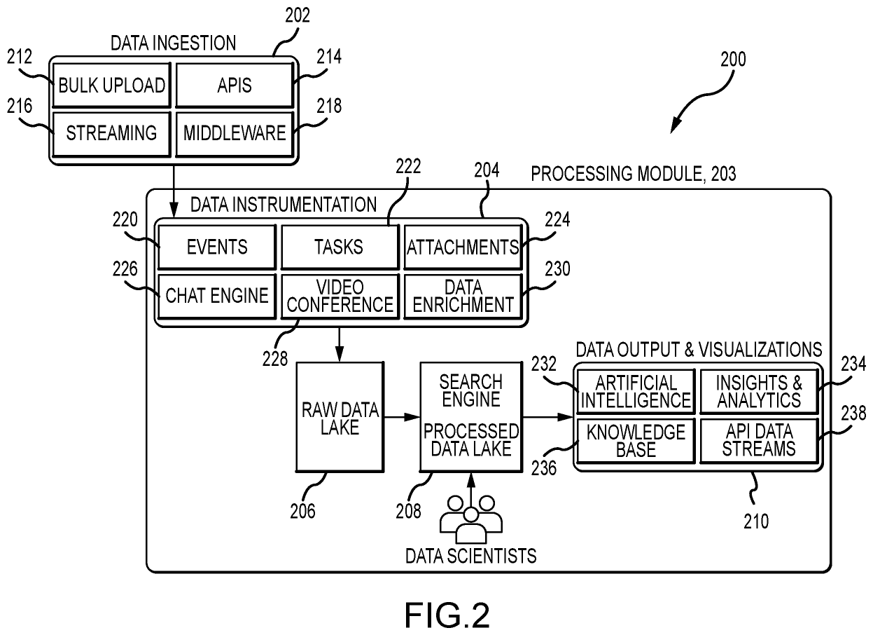

However, before further describing the details of those components, FIG. 2 shows a schematic diagram providing a further overview of the functionality provided by the system 100 of FIG. 1. Among other things, the inventive system provides a sophisticated data catalog as part of its core architecture where data instrumentation is automatic and transparent. In this regard, data instrumentation relates to extracting data objects, streams, or other units for use in analysis, as well as associating contextual information and associated metadata with the data. Currently, companies invest substantial time and money to create data governance policies, data instrumentation, data lifecycle management and data repositories before data scientists and engineers can start analyzing data in implementing processing algorithms. The present invention can implement much of this functionality in a fully or at least substantially automated fashion.

As shown in FIG. 2, the functionality is implemented by a data ingestion module 202 and a processing module 203. The data ingested by module 202 can be preprocessed by a data instrumentation module 204 that extracts, annotates, and supplements the data. The illustrated system includes a raw data lake 206 that stores the raw data and a processed data lake 208 that stores the processed data. A data output and visualization module 210 houses a knowledge base and provides outputs and analysis to users.

The data ingestion module 202 may obtain a variety of information in different forms from different sources. Such data ingestion may include bulk uploads 212, e.g., from back-end users or other users. For example, during a training process, the system may upload bulk maintenance records, part listings, user manuals, product specifications and other materials relating to an operating environment of the system. Bulk uploads may also occur during real-time operation to address specific requests. In addition, a variety of data may be ingested from APIs 214. APIs 214 may be used, for example, to enable system to system transfers of information that may assist in managing an asset.

Streaming data 216 may be received in a variety of contexts. For example, video streams from front-end users may be processed to obtain a variety of information. Similarly, videoconferencing streams, for example, between a front-end user and a subject matter expert user may be monitored to extract information for use in building a knowledge base regarding an asset and specific situations. Data may also be ingested from middleware 218 in a variety of contexts. Such middleware may provide a convenient access point to obtain raw data or structured data from various databases and systems.

As noted above, the data instrumentation module 204 is operative to extract, annotate, and supplement the ingested data. In this regard, the module 204 may extract information relating to events 220 or other ingested data. Such events may encompass any situations that can trigger a data analysis. For example, such events may include asset malfunction events, asset maintenance events, and the like. Information objects related to such events may be extracted from the data ingested by the module 202. In a variety of other contexts, the ingested information may not be triggered by or relate to any particular event. For example, in some cases, continuous or periodic monitoring may be conducted and corresponding data may be ingested independent of any event. Examples include customer equipment that includes monitoring instruments that report to a manufacturer or other monitoring party (e.g., to provide real time data for maintenance and other feedback) and medical equipment that monitors parameters of a patient at home or in a medical facility.

Tasks 222 may include scheduled tasks as well as unscheduled tasks. Examples of tasks may include particular maintenance procedures, routine monitoring procedures, periodic data upload procedures, and others. Attachments 224 include files or other data that is appended to a request or other communication from a system user. Such attachments may include text files, image files, video streams, audio files, or any other files that may be appended to a communication.

The data instrumentation module 204 further includes a chat engine 226. As noted above, the system may extract information from chat conversations, for example, between a front-end user and a subject matter expert to harvest information for use in enriching a knowledge base. In this regard, the chat engine 226 provides functionality for enabling such chat sessions as well as to monitor and extract information from the chat sessions. Similarly, the system may enable and monitor videoconferences 228. Again, such videoconferences may be between a front-end user and a subject matter expert or may be between other users. The videoconferences can be monitored such that information can be extracted for the knowledge base. The module tool for may also implement data enrichment 230. Such data enrichment 230 may involve, for example, annotating the raw data to include contextual information. Such contextual information may relate to the location of origin of the data, the system from which the data was provisioned, information regarding the personnel providing the data or an organizational association of such personnel, and identified hardware system associated with the data, or any other contextual information that may assist in understanding the data.

The illustrated system includes both a raw data lake 206 and a processed data lake 208. The raw data lake 206 provides a repository for the raw data ingested by the system. This raw data may be accessed for processing by the system to generate a processed data set. In addition, the raw data may be accessed multiple times for processing in relation to different contexts. Thus, the same data may be processed using a first data model to generate an annotated data set for use in a first context and then may be processed using a second data model to generate a second data set for use in a second context. The process data lake 208 includes data that has been processed, e.g., annotated, supplemented, and/or structured to enable work with the data by data scientists. In addition, a search engine may be provided in connection with the process data lake 208 to assist in accessing items of information based on indexes associated with the data.

In the illustrated implementation, the data output and visualization module 210 includes an artificial intelligence module 232 that employs artificial intelligence or machine learning to develop one or more models for processing the data. Such artificial intelligence may be utilized to develop a structure for the data, to identify contextual information for the data, to identify events or situations useful for processing the data, to analyze the data in relation to such events or situations, and to develop output parameters for the data. Various elements of this artificial intelligence may be supervised or unsupervised depending on the nature of the analysis. The artificial intelligence process may involve a training process, where a set of training data is supplied to the artificial intelligence engine for use in developing data processing models, and a real-time process for analyzing requests and other inputs.

The illustrated module 210 further includes an insights and analytics module 234. An important objective of the system is to provide insights and analytics that can be used, for example, by a front-end user in managing an asset. Such insights and analytics may relate to identifying correlations between events or datasets, identifying optimal intervals for maintenance and servicing, identifying variables and combinations of variables that are predictive of events, determining prophylactic and curative measures to address recurring events, and the like. The illustrated module 210 also includes a knowledge base 236. An objective of the present invention is to develop a reservoir of usable information to address a particular operating environment and context such as managing one or more capital-intensive assets. The knowledge base 236 includes the information developed in this regard as well as the models for analyzing such information for efficient and effective management. The resulting information can be output via APIs and data streams 238. For example, this information may be output to various users of a customer such as front-end users and back-end users. The information can be used to address a specific event, such as a maintenance or repair procedure, or to enhance operating procedures, for example, relating to maintenance procedures, maintenance scheduling, retiring equipment, refurbishing equipment, scheduling purchases, or the like.

It is anticipated that the system as described above will develop a large body of data over time. In particular, the cloud-based processing platform will provide a convenient mechanism to aggregate data from multiple users in multiple contexts to develop correlations as well as comparative analyses to enhance insights and analytics for users and analysts. For example, monitoring instruments associated with the same or similar equipment used in similar contexts may provide information useful in diagnosing problems or scheduling maintenance, monitoring instruments on the same or similar equipment used in different contexts may provide insights into identifying causes of problems or factors affecting maintenance, and information from hospitals using the same medical monitoring equipment may provide insights into medical equipment operation or patient conditions. Many other correlations or comparisons will be possible as data is accumulated. As noted above, such data may be anonymized, aggregated or otherwise processed to address any privacy or confidentiality concerns. The accumulated data can then be processed by machine learning modules and/or other logic to develop correlations and comparisons.

The illustrated system includes a number of useful attributes. First, the data ingestion module 204 can ingest data from a variety of external sources via a variety of means. Information may be harvested from text, voice, video streams, photographs, chat streams, videoconferencing streams, and many other sources. Moreover, as users use various features within the platform, such as the chat engine 226 and video conference function 228, data instrumentation is built into each feature to collect data in a raw format in the data lake 206. From there, data is analyzed, processed, and augmented in a fully or partially automated manner and is used to populate the processed data lake 208 where data scientists and/or artificial intelligence can work on the data to develop and implement data models and to enhance and augment the data. Outputs of the analysis and algorithm implementation result in insights and analytics, usage reporting and other information that can be fed to user systems via APIs or data streams. All of this makes it easy and fast for users to adopt the platform because massive data migration and/or platform migrations are unnecessary. In addition, users can use the results of the analysis to implement data driven decisions. It will be appreciated that developing a knowledge base platform as described above would conventionally involve a significant investment of time and money as it has been a largely a manual process. The inventive system is not only created automatically but is kept up-to-date and enhanced as new content becomes available and outdated data is purged from the system.

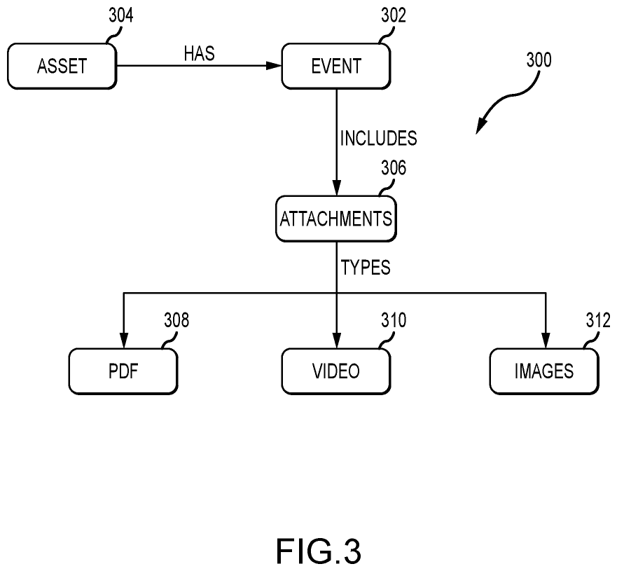

FIGS. 3-6 show additional details related to the data ingestion engine of FIG. 1 and associated functionality. FIG. 3 illustrates an example relating to a data ingestion process 300 triggered by an event 302 associated with an asset 304. For example, the asset 304 may be associated with an event 302 related to a malfunction or maintenance. It will be appreciated that data models within the system are loosely defined, thereby providing significant flexibility to address and manage a variety of kinds of events. This should not be understood as a schema-less model as the system implements controls to exclude bad data. In this regard, various types of control parameters, depending on a context, may be implemented to define mandatory properties for data acceptance.

The event 302 may involve a request from a front-end user or may be automatically generated. In either case, the event may include attachments 306. For example, the attachments 306 may include PDF documents 308 or other documents, video 310, and images 312. The PDF documents 308 may include any of a variety of documents such as maintenance records, work orders, logs, or the like. As will be described below, the PDF documents may be transcribed so that information can be extracted for analysis. The video attachments 310 may include videos of the asset or an affected system of the asset, a video inquiry or videoconference involving a front-end user, or video surveillance of an environment of the asset, among other things. The images 312 may include pictures of the asset, pictures of an affected system of the asset, scans of barcodes, QR codes or labels, or any other images that are useful in addressing the event 302.

The resulting information may be augmented with contextual information that can be attached to the raw data sets. This allows for automatic data instrumentation without asking users to manually fill in forms or add contexts. Such contextual information may involve metadata identifying the asset, identifying the location of the asset, requested for the asset, identifying the system at issue, identifying the front-end user, identifying the classification or operational structure of the operating entity, and various other kinds of information. Having one or more contextual cues for a dataset helps data scientists efficiently and accurately implement data analysis. Moreover, the system can use this contextual cue information to provide contextual search results as the system knows the context in which the search is being conducted.

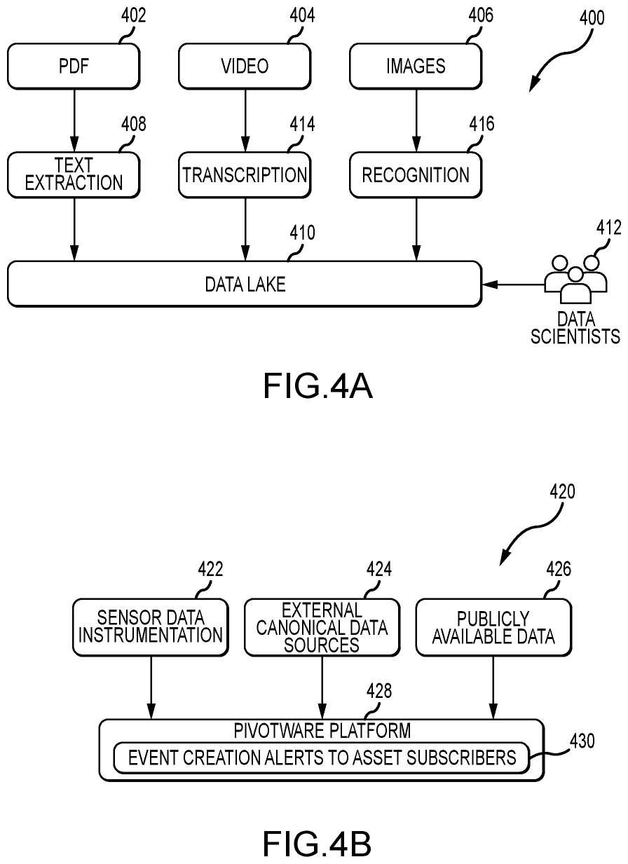

FIG. 4A illustrates a data enrichment process 400. As noted above, the input data in a particular example may include PDF documents 402, video streams 404, and images 406. Each of these can be processed for data enrichment. For example, the PDF document 402 may be processed for text extraction 408. This may involve optical character recognition, image analysis, data object identification and the like. The resulting enriched dataset can be stored in the processed data lake with associated metadata to assist in analysis by data scientists 412. Thus, when a PDF file is shared on the platform to collaborate and/or troubleshoot an issue, the system is able to extract text out of the PDF and put it into the data lake along with the context of, for example, when, how, and what caused that file sharing to happen in the first place.

In the case of video streams 404, a variety of data enrichment may occur. For example, an audio track of the video stream may be transcribed (414). In addition, textual information captured in the video stream may also be transcribed. The video stream 404 may also include barcodes, QR codes or other encoded information that can be decoded and stored with the video stream information in the data lake 410. Moreover, various image analysis functions may be implemented in relation to the video to identify and classify objects, features, or other elements included in the video stream. Similarly, image recognition functionality 416 may be applied with respect to still frame images to extract text, decode coded information, and identify and classify objects or elements included in the images 406.

The discussion above illustrated how the system can ingest data from different sources, translate them, and add more contexts to them before storing. FIG. 4B is an illustration of a much wider view of how the system 420 can be used. As shown, the system 420 can include sensor data instrumentation 422, for example, deployed in connection with an asset, so as to continuously monitor the asset with a data stream. Moreover, the system 420 can ingest data sets from external canonical data sources 424 as well as data sets that are publicly available 426. This allows the system 420 to provide a proactive solution rather than a reactive solution. The platform 428 can continuously consume data streams, and based on the user's configured anomalies, it can create an event 430 and alert asset owners of potential issues with an asset. For example, events can be generated and alerts provided in relation to thresholds set in relation to one or more parameters or conditions. These can be configured, for example, as “green”, “yellow”, “amber”, and “red” configurations so that an asset can be taken care of before it becomes unavailable for longer periods of time.

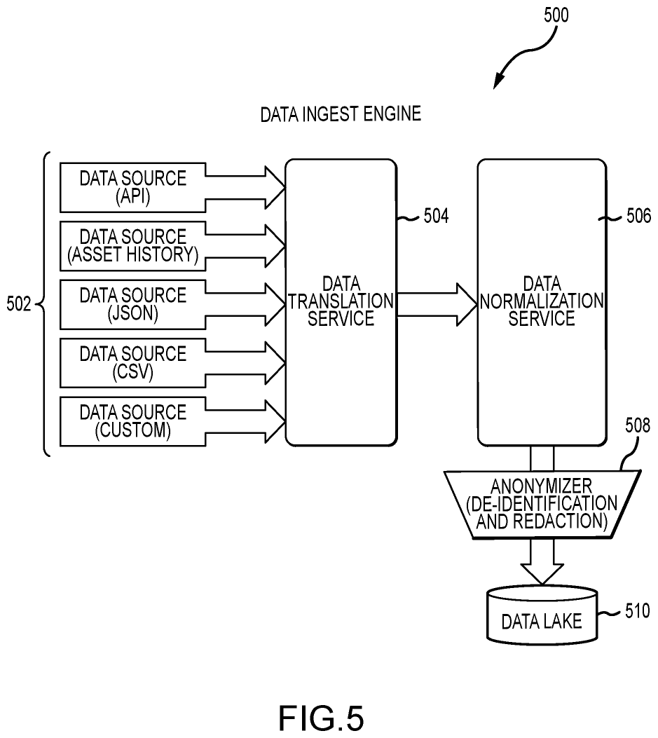

FIG. 5 illustrates a data ingest engine 500 generally corresponding to the ingest engine described in connection with FIG. 1. The illustrated engine 500 includes a number of data sources 502, a data translation service 504, a data normalization service 506, and anonymizer 508, and a data lake 510. The illustrated engine 500 is described in a particular context with particular sources and processing components. It will be appreciated that different sources and processing components may be implemented in other contexts in accordance with the present invention.

The illustrated sources 502 include an API source, and asset history source, a JSON source, a CSV source, and a custom data source. For example, the API source may extract data from user systems via a system to system interface. The asset history source may collect maintenance records, prior repair history, and other information related to an asset from systems of the user. The JSON and CSV sources are representative of different file formats that may be ingested by the engine 500. While these are common formats today, it will be appreciated that the engine 500 may accommodate many different file formats. These formats may include custom formats, for example, proprietary file formats of a given user.

It will thus be appreciated that the engine 500 is programmed or otherwise enabled to interpret the various types of data to be ingested. In this regard, each source may require its own dictionary to enable the engine 500 to properly parse the files and extract information objects. In some cases, including cases where proprietary file formats will be ingested, a dictionary specific to the context may need to be developed to enable assimilation of historic, current, and new data. It will be appreciated that the ability to add new dictionaries renders the engine 500 extremely versatile and adaptable to future needs.

The ingested data may reflect different human languages, different computer languages, or other content forms that may require translation. Understanding multiple languages provides great flexibility to the engine 500. However, a common or standardized language provides efficiencies that result in performance gains like increased processing speed. The translation service 504 converts the many sources into a standardized format that the engine 500 understands in his been optimized to handle.

Data normalization relates to scaling, reformatting, and otherwise processing data so as to enable proper comparative analysis of data from different sources. The data normalization service 506 performs such normalization with respect to different data sources. The service can unify the datasets by finding common values and adjusting each data source to adopt standardized rules of quantification. In this manner, matching and comparison of values from the different sources is facilitated.

In some cases, it may be desired to process the data for security reasons before depositing the data in the data lake 510. For example, data may include personally identifiable information, classified information, competition sensitive information, trade secret information or other information for which one or more users may wish to restrict access and use. These interests may be accommodated by the anonymizer 508. The anonymizer 508 can perform a variety of different functions in this regard including, for example, anonymizing data, aggregating data, generalizing data (e.g., reducing the accuracy of location data), redacting data, or otherwise reducing or eliminating sensitive data from the data set. Additionally or alternatively, individual data objects may be associated with flags or other metadata indicating limitations on access or use of the data. The resulting data set is placed in a data lake 510 for further processing is described below.

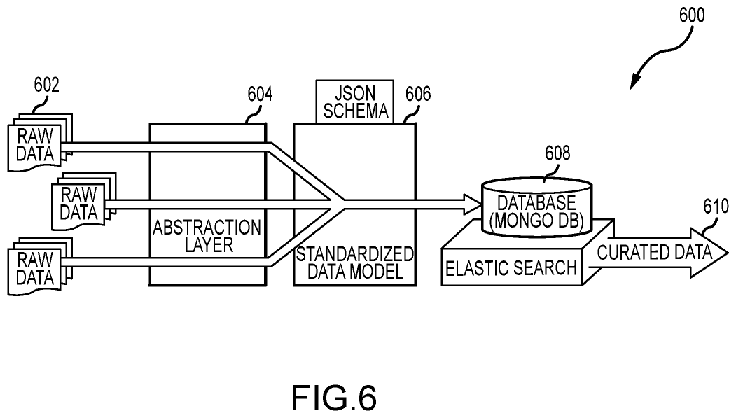

FIG. 6 shows a slightly different data ingestion process 600 corresponding to a different data processing context. As before, data is ingested from a number of sources 602. These sources may provide data in different languages, formats, and the like. These sources may include data streaming, APIs, and middleware. The abstraction layer 604 abstracts the data from these sources 602 from their native formats and languages to a common form for use in the system. All data is then normalized to a standardized data model, which may be at least loosely based on a defined JSON schema by the standardized data model functions 606. The resulting standardized data can then be stored in a database 608, in the illustrated example, a MongoDB instance. In this regard, the normalized data can be indexed by a search tool such as ElasticSearch and made available via APIs or file exports to user systems. The result is a set of curated data that can be readily and effectively employed by users. As described in more detail below, this curated data can be made available for processing by tools which perform a variety of functions such as anomaly identification, correlations, trend analysis, or other analysis. The data can also be easily employed by visualization tools such as Tableau, Sysense and others to facilitate analysis by end-users. As noted above, the data can also be deposited in a data lake were advanced analytics can be conducted by data scientists.

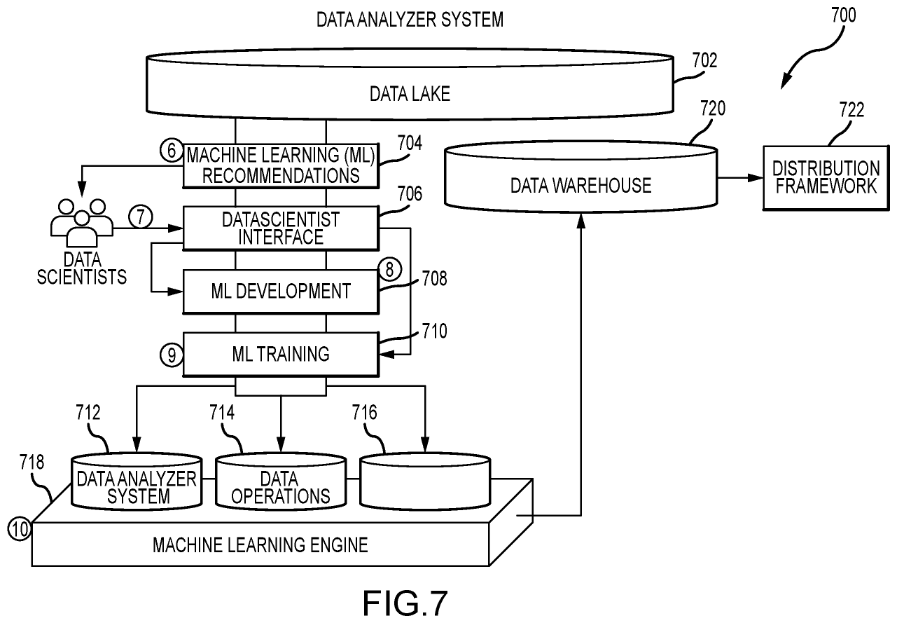

FIG. 7 is a schematic diagram illustrating a data analyzer system 700 generally corresponding to the analyzer system of FIG. 1. A machine learning module 704 accesses data from the data lake 702 for processing. Based on a data model developed during a training process, this module 704 can make recommendations for different common functions to perform on information pulled from the data lake 702. For example, the module 704 may make recommendations as to how to identify or classify a piece of data, which operations (e.g., search for duplicates, find similar patterns, etc.) To perform, and what additional meta-tags should be associated with individual items of the data.

To optimize data processing, a human interface 706 may be provided for training and/or supervising the artificial intelligence process. In the illustrated example, data scientists are able to validate assumptions, direct processing, and deploy new methods of evaluation. In this manner, new operations, algorithms, and meta-information can be added to the system in a machine learning development process 708. Processing patterns can be created, edited, or removed in this process 708. The training module 710 enables supervision of the learning process. In this regard, the module 710 can be used to train the machine learning process as to, for example, whether certain assumptions are right, wrong, close, and by how much. In this manner, the machine learning can be continually calibrated by operators to help the machine learning process to course correct as necessary. Such corrections enable accurate and meaningful recommendations with respect to future data sets.

The machine learning engine 718 is a continuously evolving logic center built to provide recommendations and enable processing for data obtained from the data lake 702. The engine 718 includes identification protocol 712, data operators 714 and meta-tag libraries 716 to assist in processing of the data. Once the data has been processed, tagged, and sorted, it can be stored in a structured state within a data warehouse 720. With the data thus structured, the system can crawl, parse, index, and retrieve information as needed and much more efficient ways. Information can then be output to various users via a distribution framework 722.

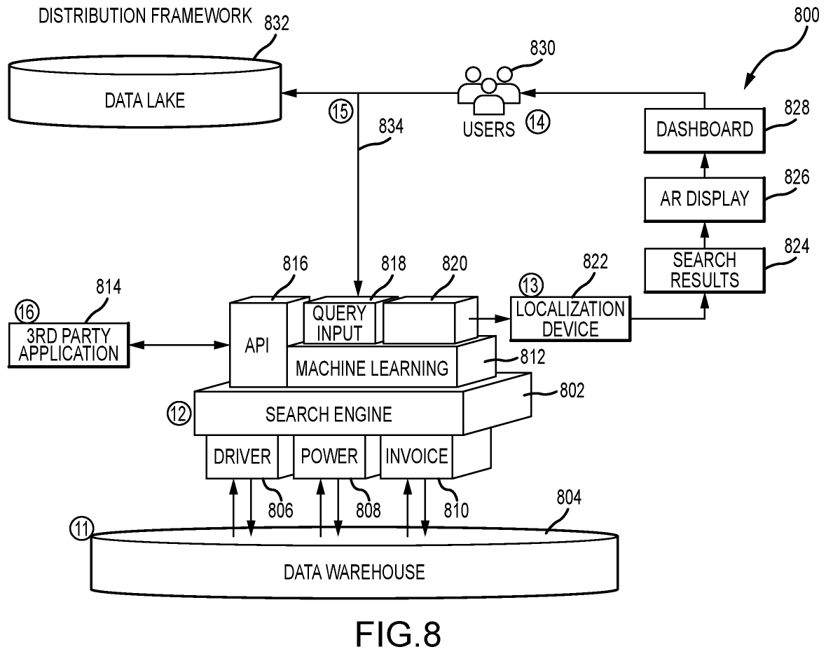

FIG. 8 is a schematic diagram of an exemplary distribution framework 800 in accordance with the present invention. At the center of the distribution framework 800 is a search engine 802. The engine 802 crawls 806, parses 808, and indexes 810 data in the data warehouse 804 continually looking for correlations between data objects, incorrect or outdated meta-tags, and executing functionality developed by the machine learning process. The engine 802 also provides the primary interface point for end-users and third-party applications via various request interfaces 818, APIs 820, and result output interfaces 820. A machine learning engine 812 is connected to the search engine 802 to analyze the search results, learn which results were useful in which were undesirable, and to thereby continually develop the search engine models for improved results.

The illustrated framework 800 also includes a localization service 822. The users 830 can interact with the process data via a variety of output modules 824, 826, and 828. In this regard, the illustrated modules include a search results module 824, and AR display module 826, and a dashboard module 828. The search results module 824 provides a search interface for submitting requests and receiving results. The AR display module 826 is operative to display documents (such as ARs). The dashboard module 828 generates and populates values for a dashboard which allows users to conveniently monitor a variety of system parameters including, for example, status indicators and metric reporting.

The framework 800 may also include input modules as generally indicated by reference numeral 834. The users 830 interact with the system through various input modules. In the case of submitting requests, users will request data from the warehouse through an input module connected to the systems machine learning engine 802 to passively train the AI to recognize usage patterns. In the case that the information is new data, it will be instead routed through the data lake 832 and associated ingest engine components for processing and tagging. To support third-party applications 814 and integrations, the system may also distribute data via a series of APIs. This enables the system to exchange information with other systems. Again, this functionality provides tremendous flexibility and creates opportunities for future expansion.

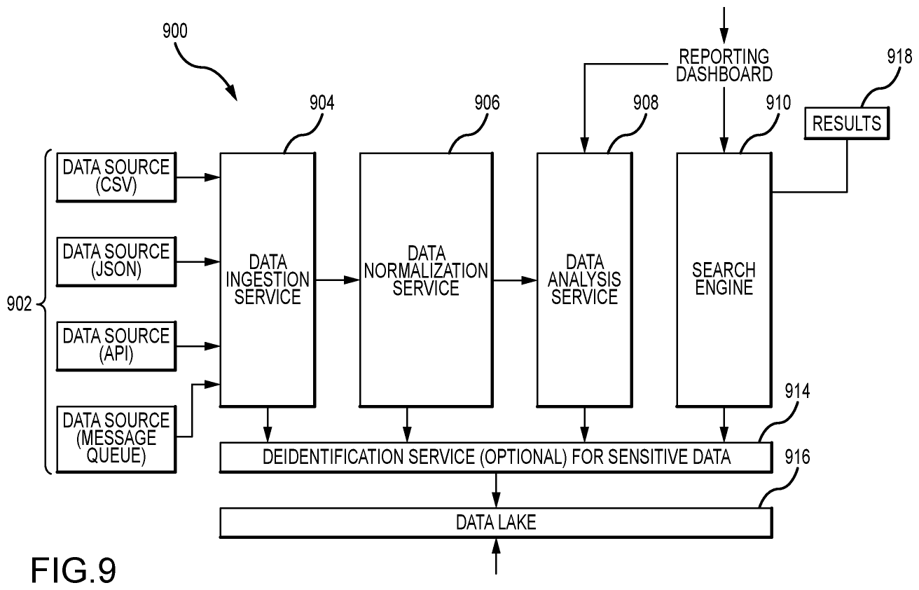

The system 900 may be summarized by reference to the block diagram of FIG. 9. The system 900 includes a data ingestion service 904 capable of consuming and retrieving a wide spectrum of information from various sources 902. In the illustrated example, the sources 902 include a CSV source, a JSON source, an API source, and a message queue source. The data normalization service 906 normalizes the ingested data to enable comparative analysis of data from different sources. The data analysis service 908 is capable of performing a variety of analyses on the normalized data to make comparisons, establish correlations, identify matches, and otherwise recognize patterns within the data. The search engine 910 is operative to receive requests or queries from users and provide results 918. A dashboard 912 provides a variety of system information in a form for easy monitoring. Data from the various services 904, 906, 908, and 910 may be passed through a de-identification service 914 to redact or otherwise process sensitive data. The resulting data is deposited in a data lake 916.

What is collected, retrieved, and displayed is easily configurable for various scenarios via micro services and applications. An important feature of the system 900 is the methods by which it collects and disperses knowledge from new and existing systems. With regard to data collection, these methodologies include passive collection, formal collection, and automated collection. Passive collection relates to monitoring all communications that pass through the data ingestion service 904. As information and events are logged by the system 900, the system 900 uses machine learning to catalog and tag this information for future retrieval. In most cases, there are no predetermined schemas to fulfill or user facing forms to fill out. More importantly, this approach imposes no extra downtime or training as it will just continually work in the background.

While the system can thus accumulate a large amount of data through passive monitoring, the system 900 is also adapted for manual data creation or formal data collection. Data can be entered into the system through more traditional import schemes such as CSV parsing, user facing forms, and similar data input methods. Automated collection involves integration with third party solutions (e.g. SAP) to automatically import information via APIs. Then, using the abstraction layer, it is easy to expand the knowledge base directly with machine telematics, inventory management systems, CRMs, and the like.

With regard to information retrieval, the system 900 supports natural language/complex queries, passive filtering, and active filtering. With regard to the queries, the system 900 combines simple conversational queries with an intuitive interface for comparative evaluations so as to allow the retrieval of complex combinations and correlations of data. These results can then be shared or embedded as widgets in the system's dashboard views. Passive filtering relates to narrowing the results of Macquarie without initial prompting based on user role, permission, and geo-located contexts, including information about the origin of the search. This functionality can be configured to allow users to customize the results or can be used to auto redact sensitive data. Active filtering involves user facing interface elements to help users reduce some of the possible noise from too broad of a query.

The results can be output or displayed in a variety of ways including internal, embedded, and external. Internal results may be provided to the system operator via a desktop, mobile or custom application of the operator. With respect to embedded results, consumable modules can be integrated into third-party solutions to deliver output information. In the case of external result delivery, data can be delivered via an API to be displayed and formatted according to third party requirements. The system 900 performs a variety of functions. 1^{st}, the system provides a knowledge base that enables customers to capture, structure, index, and securely store mission critical information and immediately make the information available to all users. The system 900 also provides a collaboration platform. This platform connects users of assets with other users and relevant data, enabling a media-rich collaboration using hardware, user interfaces, and collaboration paradigms that are familiar to users, e.g., mobile devices and messaging systems with the ability to attach images and video clips.

The system 900 also functions as expert resource management system. The system 900 finds the optimal SMEs and enables users to quickly connect with them. The optimal SME could be someone on-site or nearby or could be remotely located for cases that require specific expertise. The system 900 also functions as an asset management tool. It enables users to quickly and effortlessly retrieve relevant asset data, history, manuals, and related safety information. It is an open system that can interface with existing asset management systems. The system also utilizes facial and location information, for example, based on the user's spatial location. Finally, the system is fully customizable to best suit the needs of a particular implementation. User-facing software running on mobile devices can be branded with a user's entity or program name and logo. The back-end is able to interface with a range of existing systems. The system is designed to work along with existing software and hardware infrastructure.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A system for use in providing services for an asset using resources remote from the asset, comprising:
a platform for receiving asset information from multiple sources concerning assets and associated services, said platform being operative for receiving communications concerning assets and services for said assets, parsing said communications to obtain items of asset information, tagging said items of information with metadata related to each of said assets and said services to provide processed items of information, storing said processed items of information in a knowledge base, processing requests for requested information relating to particular assets and particular services, and providing outputs, responsive to said requests, using one or more of said processed items of information;
a front-end module, disposed on a device of a user at one of an asset location of a first asset and a remote location remote from the first asset, for uploading to said platform first asset information related to one or both of a first asset and first services for said first asset; and
a back-end module, running on a platform of an operator of said first asset, for accessing an existing system of said operator relating to at least one of subject assets of said operator including said first asset and services for said subject assets, said back-end module further being operative for providing second asset information concerning said first asset to said platform.

2. The system of claim 1, wherein said platform is operative for ingesting data from a textual conversation transmitted via said platform and monitored by said system.

3. The system of claim 2, wherein said ingested textual data is processed and stored in a searchable form in said knowledge engine.

4. The system of claim 3, wherein said ingested textual data is processed using at least one of a content of said conversation and surrounding context information to establish structural elements to supplement said ingested textual data.

5. The system of claim 1, wherein said platform is operative to extract image data from images.

6. The system of claim 5, wherein said images comprise one of still frame and video images.

7. The system of claim 5, wherein, said images are embedded in an Adobe pdf document.

8. The system of claim 5, wherein said image data is processed and stored in a searchable form in said knowledge base.

9. The system of claim 8, further comprising using at least one of a content of said images and surrounding context information to establish structural elements to supplement said extracted image data.

10. The system of claim 1, wherein said platform is operative for using said first asset information to identify a subject matter expert for collaboration in relation to said first asset.

11. The system of claim 11, further comprising a machine learning module for developing a model for use in organizing said knowledge base.

12. A method for use in providing services for an asset using resources remote from the asset, comprising:
receiving, at a processing platform, asset information from multiple sources concerning assets and associated services, said platform being operative for receiving communications concerning assets and services for said assets, parsing said communications to obtain items of asset information, tagging said items of information with metadata related to each of said assets and said services to provide processed items of information, storing said processed items of information in a knowledge base, processing requests for requested information relating to particular assets and particular services, and providing outputs, responsive to said requests, using one or more of said processed items of information;
operating a front-end module, disposed on a device of a user at one of an asset location of a first asset and a remote location remote from the first asset, for uploading to said platform first asset information related to one or both of a first asset and first services for said first asset; and
operating a back-end module, running on a platform of an operator of said first asset, for accessing an existing system of said operator relating to at least one of subject assets of said operator including said first asset and services for said subject assets, said back-end module further being operative for providing second asset information concerning said first asset to said platform.

13. The method of claim 12, wherein operating said platform for ingesting data from a textual conversation transmitted via said platform and monitored by said system.

14. The method of claim 13, wherein said ingested textual data is processed and stored in a searchable form in said knowledge engine.

15. The method of claim 14, wherein said ingested textual data is processed using at least one of a content of said conversation and surrounding context information to establish structural elements to supplement said ingested textual data.

16. The method of claim 12, further comprising operating said platform to extract image data from images.

17. The method of claim 16, wherein said images comprise one of still frame and video images.

18. The method of claim 16, wherein, said images are embedded in an Adobe pdf document.

19. The method of claim 16, further comprising processing said image data and storing said image data in a searchable form in said knowledge base.

20. The method of claim 19, wherein said processing comprises using at least one of a content of said images and surrounding context information to establish structural elements to supplement said extracted image data.

21. The method of claim 12, operating said platform for using said first asset information to identify a subject matter expert for collaboration in relation to said first asset.

22.-24. (canceled)
